(19) United States
(12) Patent Application Publication
(10) Pub. No.: US 2020/0400900 A1
(43) Pub. Date: Dec. 24, 2020

(54) OPTICAL COLLIMATION DEVICE

(71) Applicant: Commissariat à l'Énergie Atomique et aux Énergies Alternatives, Paris (FR)

(72) Inventor: Gilles Le Blevennec, Grenoble (FR)

(73) Assignee: Commissariat à l'Énergie Atomique et aux Énergies Alternatives, Paris (FR)

(21) Appl. No.: 16/905,529

(22) Filed: Jun. 18, 2020

(30) Foreign Application Priority Data
Jun. 21, 2019 (FR) 1906700

(51) Int. Cl. G02B 6/42

(52) U.S. Cl. CPC G02B 6/4206

(57) ABSTRACT

A collimation device of axis D, including a first surface placed in an outer medium having a first refraction index n₁ and receiving an electromagnetic radiation delivered by a light source located at a distance L from the first surface, and a second surface delivering the collimated electromagnetic radiation. The collimation device is mainly made of a first material having a second refraction index n₂ and the first surface is defined by the revolution around axis D of a profile defined in a plane perpendicular to axis D.

The present patent application claims the priority benefit of French patent application FR19/06700, which is herein incorporated by reference.

### TECHNICAL BACKGROUND

The present disclosure generally concerns optical collimation devices.

### PRIOR ART

For certain applications, it is desirable to have a substantially collimated light beam, that is, the light rays of the light beam are substantially parallel. This is particularly true for the transport of a light beam in a waveguide to guarantee a lossless propagation in the waveguide. However, many light sources do not generate collimated light. This is for example true for a light-emitting diode which has a wide-angle radiation pattern, typically with a 120° angle. It is then necessary to provide a collimation device between the light source and the waveguide. An example of a collimation device corresponds to a collimation lens.

Generally, the collimation device comprises an input surface receiving the light beam emitted by the light source and an output surface delivering the collimated beam. The dimensions of the output surface of the collimation device are generally greater than the dimensions of the input surface of the waveguide so that an optical coupler should be interposed between the collimation device and the waveguide to guide the collimated light emitted by the output surface of the collimation device all the way to the input surface of the waveguide.

A disadvantage is that the output surface of a collimation lens generally has a curved shape while the input surface of an optical coupler is generally planar, so that there remains a space between the collimation lens and the optical coupler, since the output surface of the collimation lens cannot be totally placed against the input surface of the optical coupler. This may make the assembly of the collimation device and of the optical coupler difficult.

### SUMMARY

Thus, an object of an embodiment is to at least partly overcome the disadvantages of the previously-described collimation devices.

An object of an embodiment is for the output surface of the collimation device to be planar.

Another object of an embodiment is for the collimation device to be capable of being placed against an optical coupler.

An embodiment provides a collimation device of axis D, comprising a first surface intended to be placed in an outer medium having a first refraction index n₁ and to receive an electromagnetic radiation delivered by a light source located at a distance L from the first surface, and a second surface intended to deliver the collimated electromagnetic radiation. The collimation device is mainly made of a first material having a second refraction index n₂ and the first surface is defined by the revolution around axis D of a profile defined in a plane perpendicular to axis D, each point of said profile being defined by an abscissa x and an ordinate y in a reference frame having its axis of abscissas contained in said plane and perpendicular to axis D and running through the center of the first surface and the axis of ordinates is axis D, the profile being the curve representative of the function y(x) obtained, to within 10%, by digital integration of the differential equation given by the relation 6) described hereafter.

According to an embodiment, the second surface is planar.

According to an embodiment, the second surface is perpendicular to axis D.

According to an embodiment, the device comprises a lateral cylindrical wall of axis D coupling the first surface to the second surface.

According to an embodiment, the first and second surfaces each have a radius in the range from 1 mm to 100 mm.

According to an embodiment, the outer medium is air.

An embodiment provides an optoelectronic system comprising a light source and a collimation device such as previously defined, the light source being capable of delivering said electromagnetic radiation and preferably being a lambertian source.

According to an embodiment, the optoelectronic system further comprises an optical coupler made of a second material, identical or different from the first material, in contact with the second surface.

According to an embodiment, the optical coupler corresponds to a frustum of axis D.

According to an embodiment, the optical device and the optical coupler form a monoblock part.

According to an embodiment, the optoelectronic device further comprises a waveguide made of a third material, identical to or different from the second material, in contact with the optical coupler.

According to an embodiment, the waveguide comprises a bundle of optical fibers.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a partial simplified cross-section view of an embodiment of a collimation device receiving a radiation emitted by a light source;

FIG. 2 is a partial simplified cross-section view illustrating geometric parameters of the collimation device of FIG. 1;

FIG. 3 shows profiles of the input surface of the collimation device for different distances between the light source and the input surface;

FIG. 4 shows a partial simplified cross-section view of an optoelectronic device comprising a light source, the collimation device of FIG. 1, an optical coupler, and a waveguide;

FIG. 5 shows a profile map of the irradiance of the radiation which escapes from the output surface of the waveguide;

FIG. 6 shows curves of the variation of the irradiance of the profile map of FIG. 5 along two perpendicular axes;

FIG. 7 shows a curve of the variation of the efficiency of the optoelectronic device of FIG. 4 according to the dimensions of the light source;

FIG. 8 shows a curve of the variation of the efficiency of the optoelectronic device of FIG. 4 for variations of the distance between the light source and the collimation device with respect to a nominal position;

FIG. 9 shows a curve of the variation of the efficiency of the optoelectronic device of FIG. 4 according to a deviation of the light source from the axis of the collimation device;

FIG. 10 shows a profile map of the irradiance of the radiation which escapes from the output surface of the waveguide for an off-centered light source.

FIG. 11 shows curves of the variation of the irradiance of the profile map of FIG. 10 along two perpendicular axes.

### DESCRIPTION OF THE EMBODIMENTS

Like features have been designated by like references in the various figures. In particular, the structural and/or functional features that are common among the various embodiments may have the same references and may dispose identical structural, dimensional and material properties. For the sake of clarity, only the elements that are useful for an understanding of the embodiments described herein have been illustrated and described in detail. Unless specified otherwise, the expressions “around”, “approximately”, “substantially” and “in the order of” signify within 10%, and preferably within 5%. In the case where the terms “about”, “approximately”, “substantially”, and “in the order of” are used in relation with a direction or an angle, they mean within 10°, preferably within 5°, of the value in question.

In the following description, the term useful radiation designates the electromagnetic radiation to be transmitted by the coupler and the term refraction index of a material designates the refraction index of the material at the wavelength of the useful radiation. As an example, it may be a radiation in the visible spectrum, infrared, or microwaves. When the useful radiation is not a monochromatic radiation, the average refraction index over the wavelength range of the useful radiation is considered. In the following description, the expression “an element mainly made of a material” means that said element comprises more than 50% by volume of said material, preferably more than 80% by volume, more preferably more than 90% by volume.

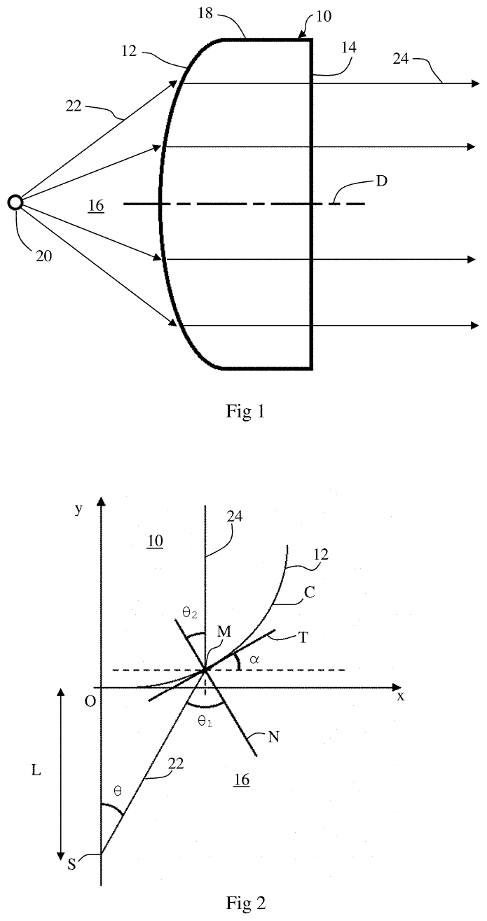

FIG. 1 is a simplified cross-section view showing a collimation device 10 having an axis D with a circular base comprising an input surface 12 and an output surface 14. According to an embodiment, collimation device 10 has a symmetry of revolution around axis D. According to an embodiment, input surface 12 is curved. According to an embodiment, output surface 14 is planar and perpendicular to axis D. Input surface 12 is in contact with an outer medium 16, for example, air. According to an embodiment, collimation device 10 comprises a cylindrical lateral wall 18 with a circular base, capable of being in contact with outer medium 16 and coupling input surface 12 to output surface 14. According to another embodiment, lateral wall 18 is not present and output surface 14 is directly coupled to input surface 12.

A light source 20 has further been shown in FIG. 1. The input surface 12 of collimation device 10 is intended to receive a non-collimated radiation, some rays 22 of which are shown in FIG. 1, emitted by light source 20, and to deliver, through output surface 14, a substantially collimated radiation, having rays 24 shown in FIG. 1. As an example, light source 20 is a light-emitting diode which is generally equivalent to a lambertian source, a lambertian source being a light source having an angularly uniform luminance, that is, a luminance which is identical in all directions.

FIG. 2 is a partial simplified cross-section view of a portion of the collimation device illustrating the principle of determination of the input surface 12 of collimation device 10. It is considered that outer medium 16 has a refraction index n₁ and that collimation device 10 has a homogeneous structure in a material having a refraction index n₂.

A reference frame (Oxy) of origin O is defined in the cross-section plane, axis (Oy) corresponding to the axis of revolution D of collimation device 10 and axis (Ox) being perpendicular to axis (Oy) and located in the cross-section plane of FIG. 2. For the determination of the shape of input surface 12, light source S is considered as being a point source placed on axis (Oy). Input surface 12 having a symmetry of revolution around axis (Oy), it is sufficient to define in reference frame (Ox, Oy) the curve C corresponding to the profile of input surface 12 in the half-plane on the right-hand side of axis (Oy). Curve C is preferably obtained to within 10%, that is, considering that curve C is representative of a function y(x), each point of the profile may deviate by + or −10% from the value of function y(x) at a given point x.

The following notations are used:
L for the distance between light source S and origin O;
(x, y) for the coordinates of a point M belonging to curve C in reference frame (Oxy);
θ for the angle between axis (Oy) and line (SM);
T for the tangent to curve C at point M;
N for the normal to curve C at point M;
α for the angle between axis (Ox) and tangent T;
θ₁ for the angle between line (MS) and normal N, that is, the angle of incidence of light ray 22 directed along line (SM) with respect to collimation device 10; and
θ₂ for the angle between normal N and ray 24, that is, the refraction angle of incident ray 22 with respect to input surface 12.

Angles θ₁ and θ₂ are linked by the Snell-Descartes law according to the following relation 1):

n₁ sin θ₁=n₂ sin η₂ [Math 1]

A collimation of the incident radiation is desired. Angles α and θ₂ are linked by the following relation 2):

α=θ₂ [Math 2]

Distance L, angle θ, and the coordinates (x, y) of point M are linked by the following relation 3):

$$tan θ = \frac{x}{y + L} \qquad [ Math 3 ]$$

Angles θ₁, θ, and α are linked by the following relation 4):

θ₁=θ+α [Math 4]

Further, the slope of tangent T is equal to angle α, which is expressed by the following relation 5):

y′(x)=tan α [Math 5]

By combining the previous relations 1) to 5) and by using the small-angle approximation, a differential equation is obtained according to the following relation 6):

y′(x)=n₁(x/(y+L))/(n₂−n₁(x/(y+L))²) [Math 6]

It is considered that input surface 12 runs through point O and that the tangent to input surface 12 at point O corresponds to axis (Ox). This is reflected by the initial conditions provided by the following relations 7):

y(0)=0 et y′(0)=0 [Math 7]

In the case where outer medium 16 is air, which corresponds to refraction index n₁ equal to 1, and where collimation device 10 is made of poly(methyl methacrylate) (PMMA), which corresponds to refraction index n₂ equal to 1.5, a digital integration of the differential equation according to relation 6) is given by the following relation 8):

$$y ( x ) = \frac{{6}^{\frac{1}{2}} {( {( {x}^{4} + 22500 )}^{\frac{1}{2}} + {x}^{2} )}^{1 / 2}}{3} - 10 \qquad [ Math 8 ]$$

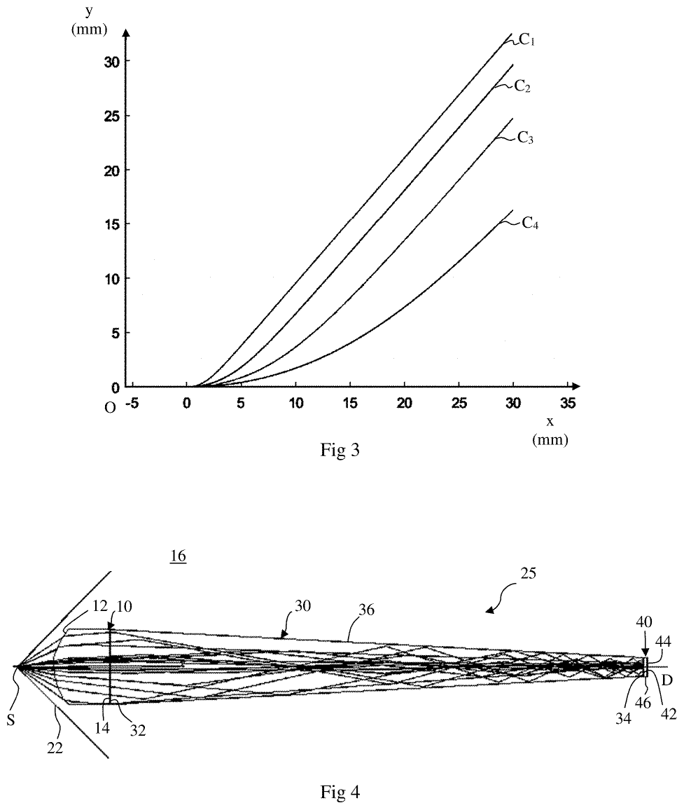

FIG. 3 shows curves C₁, C₂, C₃, and C₄ of the profile of input surface 12 determined from the previous relation 8) in the case where the distance L between light source S and center O of input surface 12 is equal respectively equal to 2 mm, 5 mm, 10 mm, and 20 mm.

FIG. 4 is a simplified cross-section view of an optoelectronic system 25 comprising the collimation device 10 shown in FIG. 1 associated with a frustoconical optical coupler 30 with a circular base in contact with a cylindrical waveguide 40 with a circular base. The shape of optical coupler 30 is given as an example, but optical coupler 30 may have another shape than that shown in FIG. 4. The shape of the input surface 12 of collimation device 10 is determined as previously described.

Optical coupler 30 comprises an input surface 32 which is placed against the output surface 14 of collimation device 10 and an output surface 34 in contact with waveguide 40. The input and output surfaces 32 and 34 of optical coupler 30 are perpendicular to axis D. Optical coupler 30 comprises a frustoconical lateral wall 36, in contact with outer medium 16, coupling input surface 32 to output surface 34. Optical coupler 30 may be made of the same material as collimation device 10 or of another material than that of collimation device 10. According to another embodiment, collimation device 10 and optical coupler 30 may correspond to a monoblock part.

Waveguide 40 comprises a planar input surface 42 placed against the output surface 34 of the output coupler and a planar output surface 44, opposite to input surface 42 and perpendicular to axis D. Waveguide 40 comprises a cylindrical lateral wall 46, in contact with outer medium 16, coupling input surface 42 to output surface 44. Waveguide 40 may be made of the same material as optical coupler 30 or of another material than that of optical coupler 30. According to an embodiment, waveguide 40 may correspond to a bundle of optical fibers.

FIG. 4 shows the travels of light rays determined by simulation. Input surface 12 follows the profile C3 of FIG. 3. Output surface 14 is planar. Input surface 32 and output surface 34 of optical coupler 30 are planar and the length of optical coupler 10 measured along axis D is 158 mm. For the simulations shown in FIG. 4, light source S is a circular source having a 0.2-mm diameter centered on axis D and perpendicular to axis D at a distance L from point O, that is, a quasi-point light source. Distance L is equal to 10 mm. Further, for the simulations, collimation device 10, optical coupler 30, and waveguide 40 are made of PMMA and outer medium 16 is air. As shown in FIG. 4, the light rays emitted by light source S are substantially collimated by collimation device 10 and are guided by optical coupler 30 all the way to waveguide 40.

As shown in the drawing, the light rays emitted by light source S are not perfectly collimated by collimation device 10. This is due to the approximations performed to determine the shape of input surface 12 and to the fact that light source S is not perfectly point-like.

Optical coupler 10 advantageously has a simple shape and may be easily manufactured, for example, by molding or by machining.

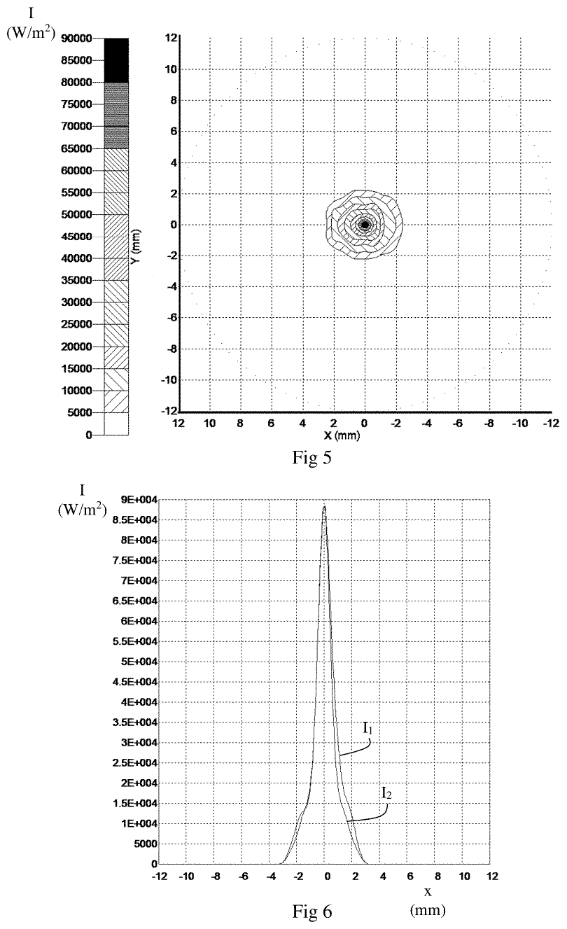

FIG. 5 shows a profile map, obtained by simulation, of the irradiance I of the radiation which escapes from the output surface 44 of the waveguide 40 of FIG. 4 in the plane of output surface 44 and FIG. 6 shows curves I₁ and I₂ of variation of irradiance I in the plane of output surface 44 along two perpendicular axes.

The dimensions of collimation device 10, of optical coupler 30, and of waveguide 40 for FIGS. 5 and 6 are those previously indicated for the simulation shown in FIG. 4, with the difference that point light source S is a circular source having a 3-mm diameter centered on axis D and perpendicular to axis D at a distance L from point O. The fact for curves I₁ and I₂ not to be perfectly confounded and for the profile map of the irradiance is due to the approximations made to determine the shape of input surface 12 and to the ray tracing statistics.

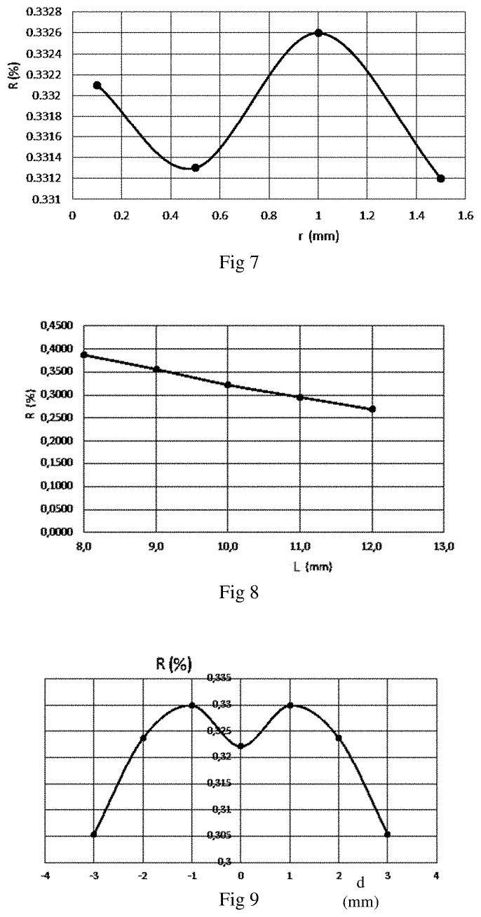

FIG. 7 shows a curve of the variation of the efficiency R of optoelectronic system 25 according to the radius r of light source S. Efficiency R corresponds to the ratio of the flux reaching the input surface 12 of collimation device 10 to the flux of the radiation escaping from the output surface 44 of waveguide 40. Efficiency R remains substantially equal to 33%, which is due to losses before reception by the input surface 12 of collimation device 10. Efficiency R thus remains substantially constant independently from the dimensions of light source S. This means that the rays remain sufficiently collimated by collimation device 10 independently from the dimensions of light source S.

FIG. 8 shows a curve of the variation of the efficiency R of optoelectronic system 25 by varying the distance L of light source S to point O, the shape of the input surface 12 of the collimation device having been determined for a distance L equal to 10 mm. A variation of efficiency R due to the geometric extension of the beam intercepted by collimation device 10 and to the effects linked to the variation of the reflection coefficients on input surface 12 can be observed. The closer light source S is to input surface 12 of collimation device 10, the greater the quantity of light injected into waveguide 40.

FIG. 9 shows a curve of the variation of the efficiency R of optoelectronic system 25 according to the distance d of light source S to axis D, light source S remaining in a plane perpendicular to axis D at distance L from point O. Efficiency R remains substantially stable until deviations with respect to axis D of from 2 mm to 3 mm are reached.

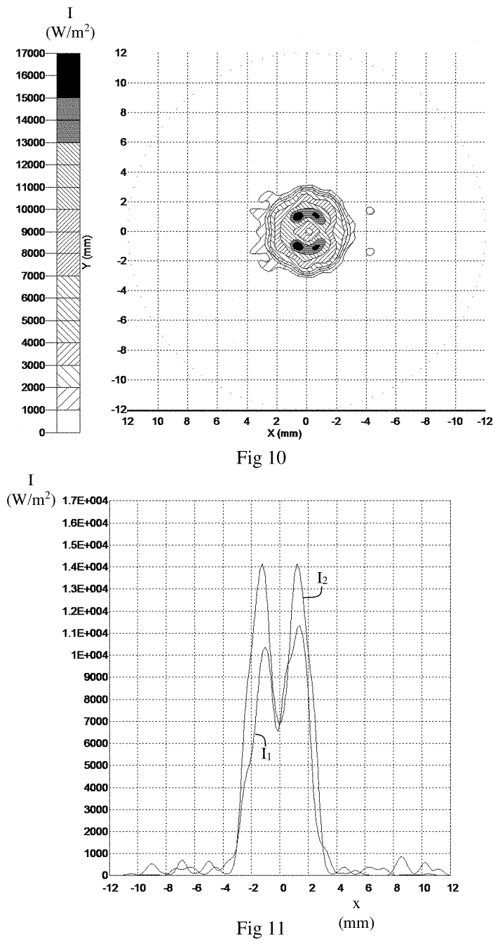

FIG. 10 shows a profile map, obtained by simulation, of the irradiance I of the radiation which escapes from the output surface of the waveguide 40 of FIG. 4 in the plane of output surface 44 and FIG. 11 shows curves I₁ and I₂ of the variation of irradiance I in the plane of output surface 44 along two perpendicular axes in the case where the source is offset by 3 mm with respect to axis D along curve measurement axis I₁. The profile map of FIG. 10 is slightly off-centered with respect to the profile map of FIG. 5.

Various embodiments and variants have been described. Those skilled in the art will understand that certain features of these embodiments can be combined and other variants will readily occur to those skilled in the art. Finally, the practical implementation of the embodiments and variants described herein is within the capabilities of those skilled in the art based on the functional indications provided hereinabove.

What is claimed is:

1. A collimation device of axis D, comprising a first surface intended to be placed in an outer medium having a first refraction index n₁ and to receive an electromagnetic radiation delivered by a light source located at a distance L from the first surface and a second surface intended to deliver the collimated electromagnetic radiation, the collimation device being mainly made of a first material having a second refraction index n₂ and the first surface being defined by the revolution around axis D of a profile defined in a plane perpendicular to axis D, each point of said profile being defined by an abscissa x and an ordinate y in a reference frame having its axis of abscissas contained in said plane and perpendicular to axis D and running through the center of the first surface and its axis of ordinates being axis D, the profile being the curve representative of the function y(x) obtained, to within 10%, by digital integration of the following differential equation:
y′(x)=n₁(x/(y+L))/(n₂−n₁(x/(y+L))²)

2. The collimation device according to claim 1, wherein the second surface is planar.

3. The collimation device according to claim 1, wherein the second surface is perpendicular to axis D.

4. The collimation device according to claim 1, comprising a lateral cylindrical wall of axis D coupling the first surface to the second surface.

5. The collimation device according to claim 1, wherein the first and second surfaces each have a radius in the range from 1 mm to 100 mm.

6. The collimation device according to claim 1, wherein the outer medium is air.

7. An optoelectronic system comprising a light source and the collimation device according to claim 1, the light source being capable of delivering said electromagnetic radiation and being preferably a lambertian source.

8. The optoelectronic system according to claim 7, further comprising an optical coupler made of a second material, identical or different from the first material, in contact with the second surface.

9. The optoelectronic system according to claim 8, wherein the optical coupler corresponds to a frustum of axis D.

10. The optoelectronic system of claim 8, wherein the optical device and the optical coupler form a monoblock part.

11. The optoelectronic system according to claim 8, further comprising a waveguide made of a third material, identical or different from the second material, in contact with the optical coupler.

12. The optoelectronic system according to claim 11, wherein the waveguide comprises a bundle of optical fibers.
